(19) United States
(12) Patent Application Publication
(10) Pub. No.: US 2025/0276281 A1
(43) Pub. Date: Sep. 4, 2025

(54) Systems for Capturing Emissions

(71) Applicant: Thalo Labs, Inc., Brooklyn, NY (US)

(72) Inventors: Brendan Hermalyn, Brooklyn, NY (US); John Kolaczynski, Brooklyn, NY (US); Samuel Patterson, Brooklyn, NY (US); Mihir Juvvadi, Brooklyn, NY (US); Thomas Evenat, Brooklyn, NY (US); Peter Schultz, Providence, RI (US)

(21) Appl. No.: 19/212,490

(22) Filed: May 19, 2025

Related U.S. Application Data
(63) Continuation of application No. 18/466,402, filed on Sep. 13, 2023, now Pat. No. 12,330,116.
Application No. 18/466,402 is a continuation of application No. 18/096,529, filed on Jan. 12, 2023, now Pat. No. 12,121,853.
(60) Provisional application No. 63/298,940, filed on Jan. 12, 2022.

(51) Int. Cl. B01D 53/62; B01D 53/00; B01D 53/34

(52) U.S. Cl. CPC B01D 53/62; B01D 53/005; B01D 53/346; B01D 2251/604; B01D 2257/504; B01D 2258/0283

(57) ABSTRACT

A system for directly capturing and measuring greenhouse gasses from a mixture of gasses over a wide range of concentrations from ambient air to combustion exhaust products including: an emissions capture reaction vessel; a reaction media container configured to house a volume of reaction media, the reaction media configured to extract a constituent gas from gas flowing through the emissions capture reaction vessel and capture constituent gas; an intake and exhaust manifold configured to receive and release, respectively a portion of a gas stream via a first access tap on the exhaust stack; a computer system comprised of sensors and actuators connected to a network to directly measure efficiency and uptake of a system, and a fan arranged within the housing and configured to influence the amount and speed of the gas stream.

### CROSS-REFERENCE TO RELATED APPLICATIONS

This Application is a continuation of and claims the benefit of U.S. application Ser. No. 18/466,402, filed on Sep. 13, 2023, which is a continuation of and claims the benefit of U.S. application Ser. No. 18/096,529, filed on Jan. 12, 2023 (now U.S. Pat. No. 12,121,853), which claims the benefit of U.S. Provisional Application No. 63/298,940, filed on Jan. 12, 2022, each of which is incorporated in its entirety by this reference.

### TECHNICAL FIELD

This invention relates generally to the field of emissions capture and more specifically to a new and useful system for capturing emissions in the field of emissions capture.

### BRIEF DESCRIPTION OF THE FIGURES

FIG. 1 is a flowchart representation of a system;

FIGS. 2A, 2B, 2C, and 2D are schematic representations of variations of the system;

FIG. 3 is a flowchart representation of one variation of the system;

FIG. 4 is a flowchart representation of one variation of the system;

FIG. 5 is a flowchart representation of one variation of the system; and

FIG. 6 is an electrical block diagram of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

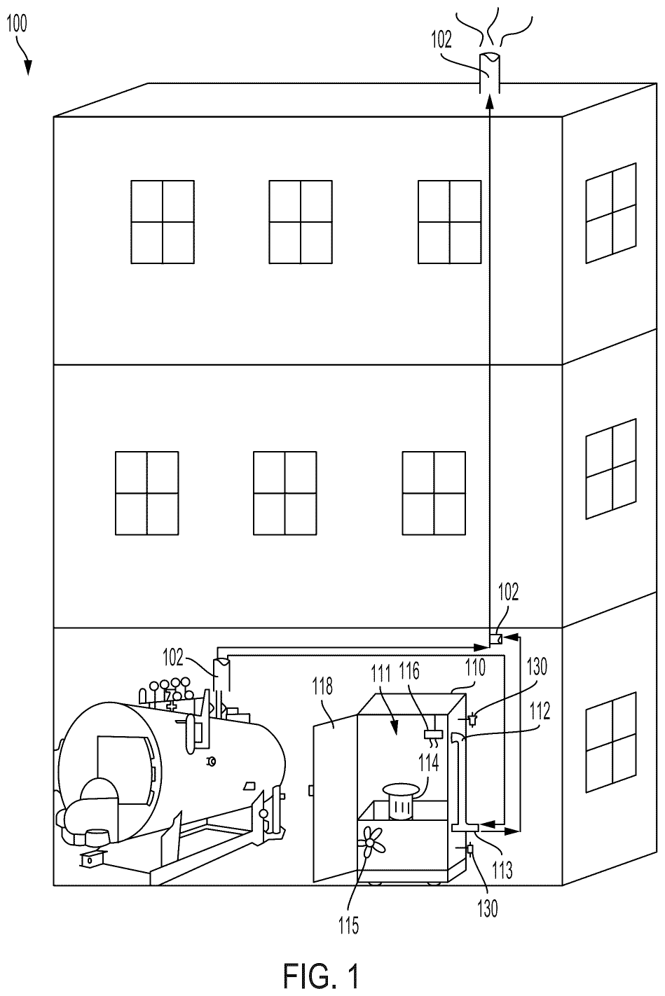

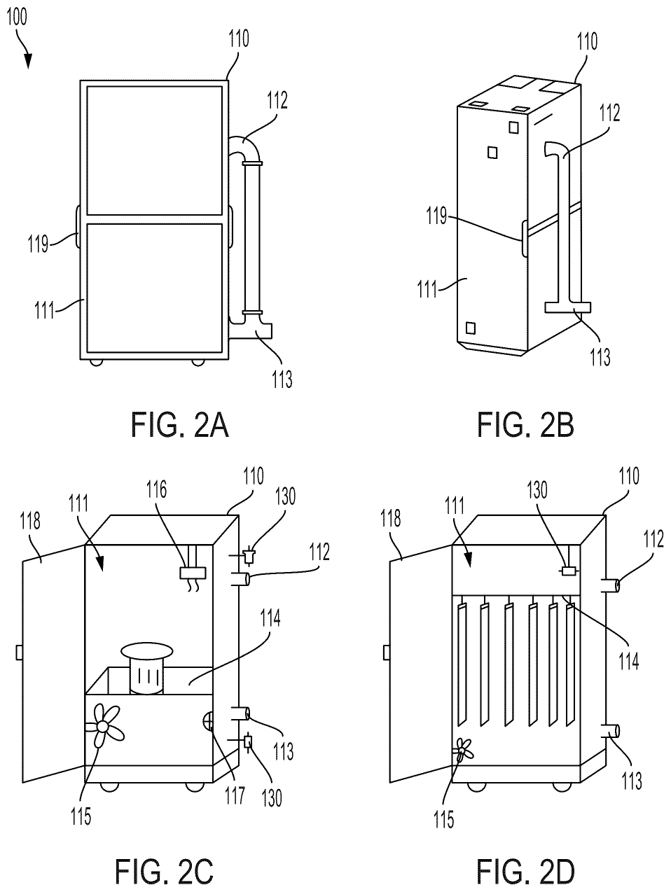

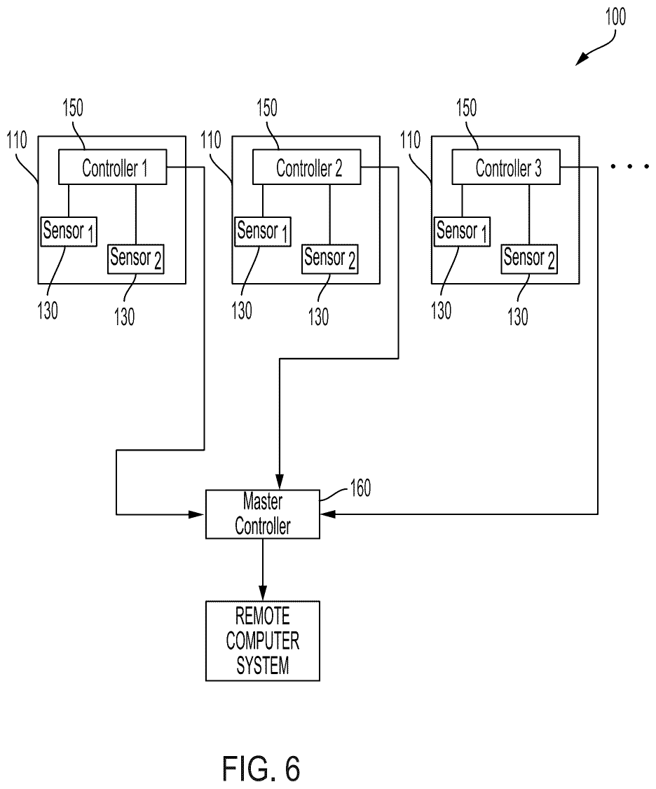

As shown in FIGS. 1-6, a system 100 for directly capturing emissions from an exhaust stack 102 in a building includes: an emissions capture reaction vessel 110; a housing 111; a reaction media container 114; a housing inlet 113; a housing outlet 112; and a fan 115.

The emissions capture reaction vessel 110 can be arranged proximal the exhaust stack 102 and includes: a housing 111; a reaction media container 114 arranged within the housing 111 and configured to house a volume of reaction media, the reaction media configured to extract a constituent gas from flowing through the emissions capture reaction vessel 110 and capture constituent gas; a housing inlet 113 arranged on the housing 111 and configured to receive a portion of an exhaust gas stream, exhausting through the exhaust stack 102 and inbound to the emissions capture reaction vessel 110, via a first access tap at a first height on the exhaust stack 102 and configured to feed the portion of the exhaust gas stream toward the reaction media container 114; a housing outlet 112 arranged on the housing 111 and configured to return the portion of the exhaust gas stream, exiting the reaction media container 114, back to the exhaust stack 102 via a second access tap at a second height, greater than the first height, on the exhaust stack; and a fan 115 arranged within the housing 111 and configured to influence the portion of the exhaust gas stream from the housing inlet 113, over the reaction media container 114, and through the housing outlet 112.

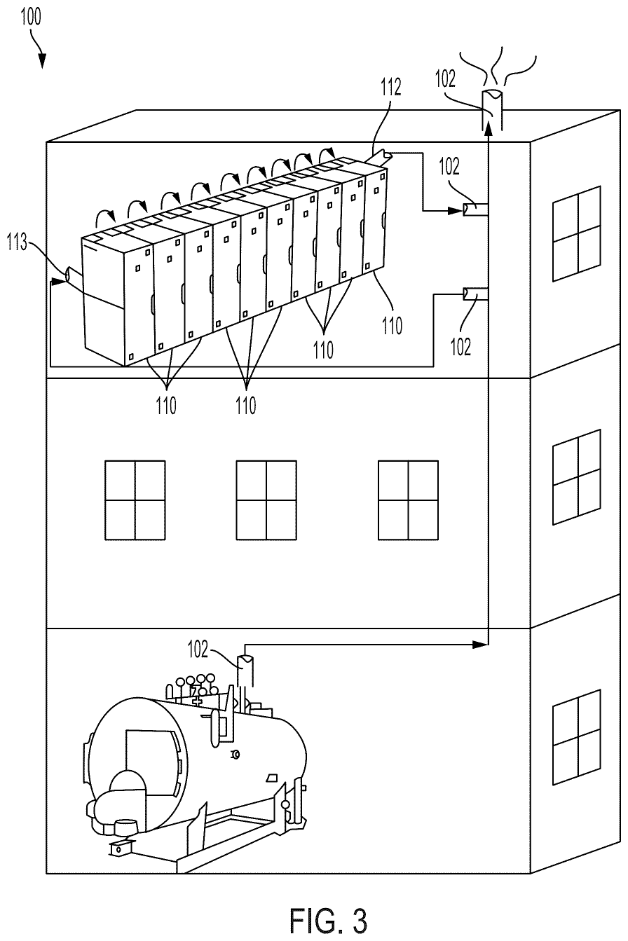

As shown in FIG. 3, one variation of the system 100 includes a first emissions capture reaction vessel 110 and includes: a first housing 111; a first reaction media container 114 arranged within the first housing 111 and configured to house a volume of reaction media, the reaction media configured to extract a constituent gas from gas flowing through the first emissions capture reaction vessel 110 and capture constituent gas; a first housing inlet 113 arranged on the first housing 111 and configured to receive a portion of an exhaust gas stream, exhausting through the exhaust stack 102 and inbound to the first emissions capture reaction vessel 110, via a first access tap at a first height on the exhaust stack 102 and configured to feed the portion of the exhaust gas stream toward the reaction media container 114; a first housing outlet 112 arranged on the first housing 111 and coupled to a second housing inlet 113 of a second emissions capture reaction vessel 110. The system 100 further includes a second emissions capture reaction vessel 110 and includes: a second housing 111; a second reaction media container 114 arranged within the second housing 111 and configured to house the volume of the reaction media, the reaction media configured to extract the constituent gas from gas flowing through the second emissions capture reaction vessel 110 and capture constituent gas; a second housing inlet 113 arranged on the second housing 111 and configured to return the portion of the exhaust gas stream, exiting the second reaction media container 114, back to the exhaust stack 102 via a second access tap at a second height, greater than the first height, on the exhaust stack 102.

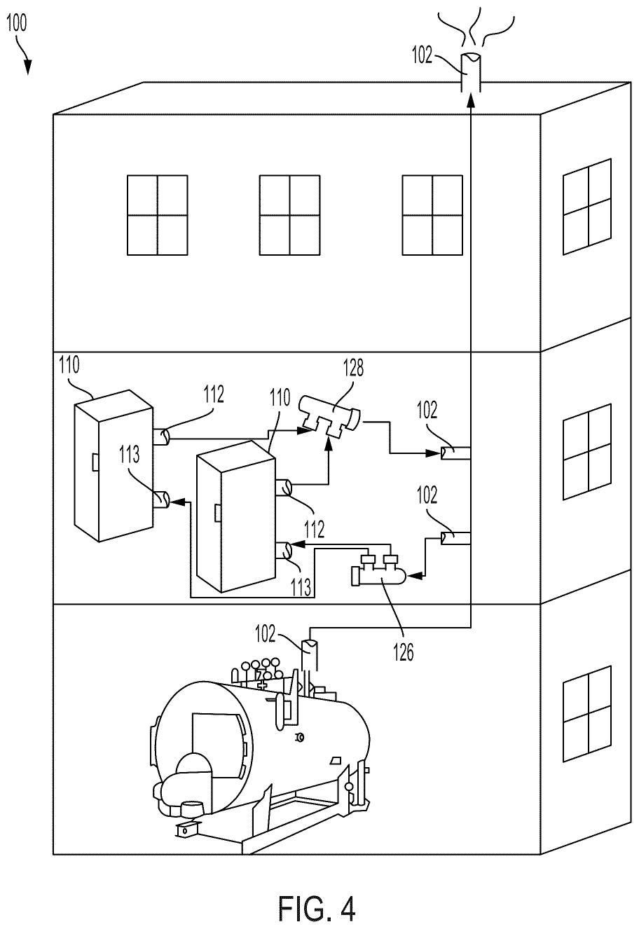

As shown in FIG. 4, one variation of the system 100 includes: a housing inlet manifold 126 coupled to a first access tap at a first height on an air supply; a housing outlet manifold 128 coupled to a second access tap at a second height, greater than the first height, on the air supply 102; and a first emissions capture reaction vessel 110. The first emissions capture reaction vessel 110 includes: a first housing 111; a first reaction media container 114 arranged within the first housing 111 and configured to house a volume of reaction media, the reaction media configured to extract a constituent gas from gas flowing through the first emissions capture reaction vessel 110 and capture constituent gas; a first housing inlet 113 arranged on the first housing 111, coupled to the housing inlet manifold 126, and configured to receive a first portion of a gas stream from the air supply via the housing inlet manifold 126; and a first housing outlet arranged on the first housing 111, coupled to the housing outlet manifold 128, and configured to return the first portion of the gas stream back to the air supply 102 via the housing outlet manifold 128. The system 100 also includes a second emissions capture reaction vessel 110 and includes: a second housing 111; a second reaction media container 114 arranged within the second housing 111 and configured to house the volume of the reaction media, the reaction media configured to extract the constituent gas from gas flowing through the second emissions capture reaction vessel 110 and capture constituent gas; a second housing inlet 113 arranged on the second housing 111, coupled to the housing inlet manifold 126, and configured to receive a second portion of the gas stream from the air supply 102 via the housing inlet manifold 126; and a second housing outlet 112 arranged on the second housing 111, coupled to the housing outlet manifold 128, and configured to return the second portion of the gas stream back to the air supply via the housing outlet manifold 128.

### 2. Applications

Generally, the system 100 includes an emissions capture reaction vessel 110 that includes: a housing 111; a reaction media container 114; a housing inlet 113; a housing outlet 112; and a fan 115. The system 100 can also include: a set of sensors 130 (e.g., gas sensors, temperature sensors, gas flow sensors); a controller 150; and/or a remote computer system that cooperate to: capture a portion of an exhaust gas stream exhausting through an exhaust stack 102 coupled to a utility system-such as a boiler, a furnace, a water heater, a space heater, an air heater, a drying machine, a fireplace, a generator, a cogeneration device-located within and/or on a building (e.g., educational building, industrial building) from a first access tap on the exhaust stack 102; absorb constituent gas (e.g., carbon dioxide) from this portion of the exhaust gas stream and capture constituent gas (e.g., carbon dioxide) via reaction media (e.g., a metal oxide or hydroxide solid) housed within the reaction media container 114 of the emissions capture reaction vessel 110; and return the portion of the exhaust gas stream (e.g., processed gas) back into a second access tap on the exhaust stack 102.

More specifically, the emissions capture reaction vessel 110 can include: a housing 111; a housing inlet 113 configured to receive the portion of the exhaust gas stream from the first access tap at a first height on the exhaust stack 102; a reaction media container 114 arranged within the housing and configured to house reaction media. The reaction media can: extract a constituent gas (e.g., carbon dioxide) from the exhaust gas stream; and capture the constituent gas (e.g., carbon dioxide) for sequestering during a future time period. The emissions capture reaction vessel 110 also includes a housing outlet 112 configured to return the portion of the exhaust gas stream back into a second access tap at a second height, greater than the first height, on the exhaust stack 102.

In one implementation, the system 100 can be configured to include a set of emissions capture reaction vessels 110 (e.g., 3 emissions capture reaction vessels, 10 emissions capture reaction vessels, 20 emissions capture reaction vessels) to capture carbon corresponding to carbon emissions (e.g., 2,000 parts-per-million of carbon dioxide, 10,000 parts-per-million of carbon dioxide, 80,000 parts-per-million of carbon dioxide) from an exhaust stack 102 connected to a utility system located within and/or on an educational building.

In one variation, the system 100 can be configured to include a set of emissions capture reaction vessels 110 configured to capture carbon from a low carbon dioxide concentration emitting exhaust stack 102 connected to a furnace located within and/or on a building. In another variation, the system 100 can be configured to include a set of emissions capture reaction vessels 110 configured to capture carbon from a high carbon dioxide concentration emitting exhaust stack 102 connected to a boiler located within and/or on an industrial building.

Furthermore, the controller 150 can cooperate with a remote computer system to: read timeseries concentrations of the portion of the exhaust gas stream from a gas sensor 130, gas flow rates from a gas flow rate sensor 130, and temperatures from a temperature sensor 130 during a processing cycle; monitor gas flow rate, mass flux, and temperature via the set of sensors (e.g., gas sensors, gas flow rate sensors, temperature sensors); execute actions (e.g., generate notifications) indicating removal and replacement of reaction media housed within the reaction media container 114 of the emissions capture reaction vessel 110; selectively trigger actuators-such as a fan 115, a heating element 116 and/or a valve 140—within the system 100 and thereby achieve minimal to no generation of constituent gases (e.g., carbon monoxide, nitrogen oxide, sulfur oxide) and combustion of gas within the system 100 and/or within the building during a processing cycle.

In one variation, the system 100 can include an emissions capture reaction vessel 110 that includes: a housing 111; a reaction media container 114; a housing inlet 113; a housing outlet 112; a fan 115; a set of sensors 130 (e.g., gas sensors, temperature sensors, gas flow sensors); a controller 150; and/or a remote computer system that cooperate to capture a portion of greenhouse gasses from an air supply within a building (e.g., ambient indoor air or located near or in the flow of a circulating HVAC system or air handler) and/or outside of a building (e.g., an industrial building, a sports arena, a data center, a manufacturing facility, a stadium). Furthermore, the system 100 can process both: combustion exhaust gas (e.g., when a boiler or other building system is in operation); and non-combusted gas (e.g., when the boiler or other building system is inactive).

### 3. System

As described above, the system 100 includes an emissions capture reaction vessel 110 that can be arranged proximal an exhaust stack 102 in a building and includes: a housing 111; a reaction media container 114 arranged in the housing 111 and configured to house a volume of a reaction media; a housing inlet 113 arranged on the housing 111 and configured to receive a portion of the exhaust gas stream via a first access tap at a first height on the exhaust stack 102; a housing outlet 112 arranged on the housing 111 and configured to return the portion of the exhaust gas stream (e.g., processed gas), exiting the reaction media container 114, back to the exhaust stack 102 via a second access tap on the exhaust stack 102; from the housing 111 to the exhaust stack 102; and a fan 115 arranged within the housing 111 and configured to extract (e.g., pull) gas from the exhaust stack 102 into the housing inlet 113 and configured to influence the portion of the exhaust gas stream from the housing inlet, over the reaction media container 114, and through the housing outlet 112. The system 100 can also include a heating element 116, a filter 117, a door 118, an interlock 119, a set of couplers 120, and/or a valve 140.

### 3.1 Housing Inlet+Housing Outlet+Reaction Media Container

The emissions capture reaction vessel 110 includes: a housing 111; a reaction media container 114 arranged within the housing 111 and configured to house a volume of reaction media (e.g., sorbent); a housing inlet 113 arranged on the housing 111; and a housing outlet 112 arranged on the housing 111.

In one implementation, the housing inlet 113 is arranged on the housing 111 and configured to receive a portion of an exhaust gas stream, exhausting through the exhaust stack 102 and inbound to the emissions capture reaction vessel 110, via a first access tap at a first height on the exhaust stack 102 and configured to feed the portion of the exhaust gas stream toward the reaction media container 114. The reaction media container 114 is arranged within the housing 111 and is configured to house a volume (e.g., 80 kg, 100 kg) of reaction media. The reaction media can extract (e.g., absorb, adsorb) a constituent gas (e.g., carbon dioxide) from the portion of the exhaust gas stream flowing through the emissions capture reaction vessel 110 and capture the constituent gas (e.g., carbon dioxide) for sequestration. The housing outlet 112 is arranged on the housing 111 and configured to return the portion of the exhaust gas stream, exiting the reaction media container 114, back to the exhaust stack 102 via a second access tap at a second height, greater than the first height, on the exhaust stack 102.

In one variation, the reaction media container 114 can include a baghouse—such as a shaker baghouse, a reverse air baghouse, a pulse jet baghouse—that includes a set of bags configured to house the volume of reaction media (e.g., calcium oxide, hydroxides, amines, metal organic framework). The reaction media can capture the constituent gas and convert the constituent gas into a carbon product (e.g., carbonate, compressed liquefied carbon dioxide, elemental carbon, ethanol, calcium carbonate) during a processing cycle. Once the total constituent gas absorbed by the reaction media approaches a constituent gas capacity (e.g., maximum capacity of the reaction media), a bag in the set of bags within the baghouse can be removed from the reaction media container 114 and replaced with a bag configured to house the volume of new reaction media. Alternatively, the reaction media container 114 can include any other container (e.g., tube, tray, bucket, bottle) configured to house any other volume of reaction media within the housing 111 of the emissions capture reaction vessel 110 and can be replaced once the total constituent gas absorbed by the reaction media approaches the constituent gas capacity.

Furthermore, the system 100 can include an external reaction media container 114 configured to house a second volume of reaction media, the reaction media can extract (e.g., absorb, adsorb) a constituent gas (e.g., carbon dioxide) from the portion of the exhaust gas stream flowing through the emissions capture reaction vessel 110 into the external media container 114 and return the portion of the exhaust gas stream based into the housing inlet 113 of the emissions capture reaction vessel 110.

### 3.2 Fan

The emissions capture reaction vessel 110 can also include a fan 115. The fan 115 is arranged within the housing 111 and configured to influence the portion of the exhaust gas stream from the housing inlet 113, over the reaction media container 114, and through the housing outlet 112.

In one variation, the fan 115 can be configured to influence the portion of the exhaust gas stream flowing through the housing 111 of the emissions capture reaction vessel 110 at a first speed in order to reduce carbon monoxide generation and/or combustion of gas moving through the system 100.

In another variation, the fan can be configured to influence the mass flux of the exhaust gas stream from the housing inlet 113, over the reaction media container 114, and through the housing outlet 112.

### 3.3 Heating Element+Filter

The emissions capture reaction vessel 110 can also include a heating element 116 and/or a filter 117. The heating element 116 can be arranged within the housing 111 at the housing outlet 112 of the emissions capture reaction vessel 110 and can be configured to increase the temperature of gas moving through the emissions capture reaction vessel 110. The filter 117 can be arranged within the housing 111 at the housing inlet 113 of the emissions capture reaction vessel 110 and can be configured to remove constituent gases (e.g., nitrogen oxide, sulfur oxide, carbon monoxide) from gas entering the housing inlet 113 of the emissions capture reaction vessel 110 prior to commencement of a processing cycle.

### 3.4 Valve

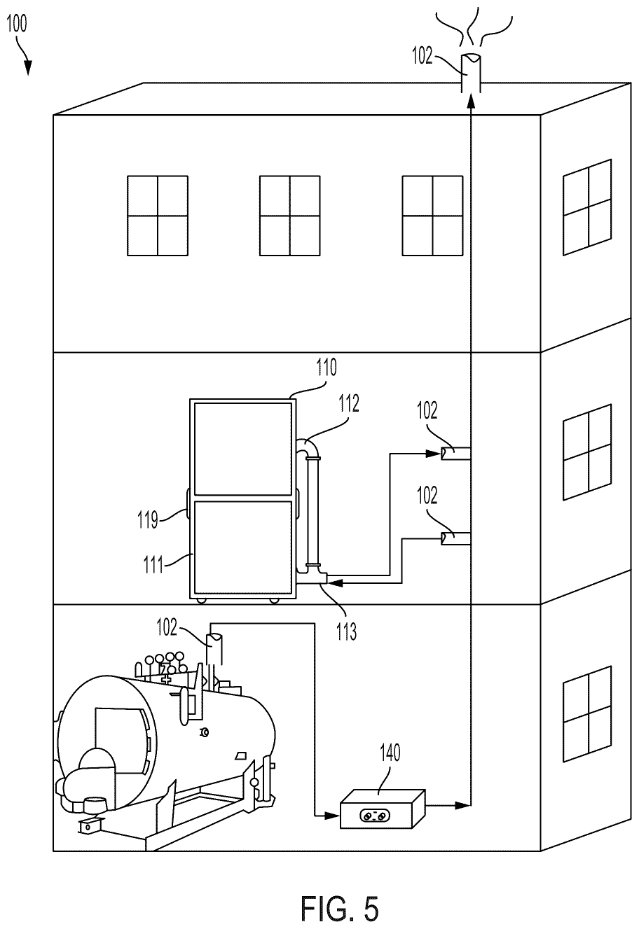

As shown in FIG. 5, the system 100 can further include a valve 140 interposed between the housing inlet 113 and the first access tap on the exhaust stack 102 and configured to close at the housing inlet 113 to prevent the exhaust gas stream from entering the housing inlet 113.

In one variation, the valve 140 is configured to operate in an open position to convey the portion of the exhaust gas stream through the emissions capture reaction vessel 110 and in a closed position to prevent the portion of the exhaust gas stream from entering the housing 111 via the housing inlet 113. In this variation, a user (e.g., technician, custodial staff, administrator, manager) affiliated with the building can operate (e.g., turn, rotate) the valve 140 to an open position such that the exhaust gas stream can flow from the first access tap on the exhaust stack 102 into the housing inlet 113 of the emissions capture reaction vessel 110. The user can also operate the valve 140 in a closed position to reduce movement of the exhaust gas stream from entering into the emissions capture reaction vessel 110.

Thus, the user can quickly service the emissions capture reaction vessel 110—such as removing the reaction media container 114 and the volume of reaction media within the reaction media container 114, filling the reaction media container 114 with new reaction media, and returning the reaction media container 114 to the housing 111—once the valve 140 is in a closed position.

### 3.5 Door+Interlock

The emissions capture reaction vessel 110 further includes a door 118 configured to open to enable transfer of a replacement volume of reaction media into the emissions capture reaction vessel 110 and an interlock 119 coupled to the door.

In one variation, the emissions capture reaction vessel 110 can include a bag removably coupled to the reaction media container 114 and configured to house the volume of the reaction media. The reaction media can extract the constituent gas from gas flowing through the first emissions capture reaction vessel 110 and capture constituent gas. In this variation, the door 118 is configured to open to enable transfer of a replacement bag configured to house the volume of the reaction media.

In yet another variation, the door 118 is configured to enable transfer of a replacement volume of reaction media into the reaction media container 114 within the housing 111 of the emissions capture reaction vessel 110. In this variation, the valve 140 is arranged between the housing inlet 113 and the first access tap on the exhaust stack 102 and configured to close at the housing inlet 113 to prevent the portion of the exhaust gas stream from flowing through the emissions capture reaction vessel 110 and the interlock 119 is coupled to the door 118 and configured to open the door in response to a threshold duration of time of closure of the valve 140, and thereby prevents gas from exiting the emissions capture reaction vessel 110 through the door 118 when the emissions capture reaction vessel 110 is serviced.

### 3.6 Couplers

The system 100 can further include a set of couplers 120 interposed between the emissions capture reaction vessel 110 and the exhaust stack 102.

In one implementation, a first coupler 120, in the set of couplers 120, is configured to fluidly couple to the first access tap at the first height on the exhaust stack 102 and a second coupler 120, in the set of couplers 120, is configured to fluidly couple to the second access tap at the second height, greater than the first height, on the exhaust stack 102. In this implementation, the housing inlet 113 is coupled to the first coupler 120 and configured to receive the portion of the exhaust gas stream from the exhaust stack 102 via the first coupler 120 and the housing outlet 112 is coupled to the second coupler 120 and configured to return the portion of the exhaust gas stream back to the exhaust stack 102 via the second coupler 120.

### 4. Sensors

Generally, the system 100 includes a set of sensors 130 coupled to the emissions capture reaction vessel 110 and each sensor, in the set of sensors 130, is configured to collect non-optical data—such as concentration of gas, gas flow rate, and/or temperature of gas—as gas (e.g., carbon dioxide greenhouse gases) moves through the emissions capture reaction vessel 110 during a processing cycle.

In one implementation, the system 100 includes a first sensor 130 arranged proximal the housing inlet 113 and a second sensor 130 arranged proximal the housing outlet 112. The first sensor 130 is configured to collect non-optical data-such as concentration of gas, gas flow rate, and/or temperature—of the portion of the exhaust gas stream entering the housing via the housing inlet 113 during a processing cycle and the second sensor 130 is configured to collect non-optical data—such as concentration of gas, gas flow rate, and/or temperature—of the portion of the exhaust gas stream exiting the housing via the housing outlet 112.

### 4.1 Gas Sensors

In one variation, the system 100 includes a set of gas sensors 130 configured to output signals corresponding to a concentration (e.g., in parts per million): of constituent gas from the portion of the exhaust gas stream (e.g., constituent gas greenhouse gases) exiting the first access tap on the exhaust stack 102 within and/or on a building; and of constituent gas from the portion of the exhaust gas stream (e.g., processed gas) exiting the housing outlet 112 of the emissions capture reaction vessel 110 back into the second access tap of the exhaust stack 102.

In one variation, the system 100 includes a first gas sensor 130 arranged proximal the housing inlet 113 and configured to output a first signal corresponding to a first concentration of the constituent gas (e.g., carbon dioxide) from the exhaust gas stream entering the first housing via the housing inlet. The system 100 also includes a second gas sensor 130 arranged proximal the housing outlet 112 and configured to output a second signal corresponding to a second concentration of constituent gas (e.g., carbon dioxide) from the exhaust gas stream, less than the first concentration of gas, exiting the housing outlet 112 of the emissions capture reaction vessel 110 back into the second access tap of the exhaust stack 102.

In another variation, the system 100 includes a spectrometer configured to detect a concentration of constituent gas (e.g., carbon dioxide) from the portion of the exhaust gas stream exiting the exhaust stack 102 and a second concentration of constituent gas (e.g., carbon dioxide) from the portion of the exhaust gas stream, less than the first concentration of gas, exiting the housing outlet 112 of the emissions capture reaction vessel 110.

Additionally and/or alternatively, the system 100 can include a first gas flow sensor 130—such as a wire anemometer or other gas flux sensor 130—arranged proximal the housing inlet 113 and configured to output a first signal corresponding to a first flow rate of constituent gas (e.g., carbon dioxide) from the exhaust gas stream entering the housing via the housing inlet. The system 100 also includes a second gas flow sensor 130—such as a wire anemometer or other gas flux sensor 130—arranged proximal the housing outlet 112 and configured to output a second signal corresponding to a second flow rate of constituent gas (e.g., carbon dioxide) from the exhaust gas stream exiting the housing via the housing outlet 112.

Once the system 100 is deployed proximal the exhaust stack 102 in and/or on a building, the controller 150 can: sample these gas flow sensors 130, such as at a rate of 1 Hz or once per minute; store these data in local memory; and/or stream these data to the remote computer system for further processing.

### 4.2 Temperature Sensors

Furthermore, the system 100 can include a set of temperature sensors 130 configured to output signals corresponding to a temperature of the portion of the exhaust gas stream entering the housing via the housing inlet 113 and/or a temperature of the portion of the exhaust gas stream exiting the housing 111 via the housing outlet 112.

In one implementation, a first temperature sensor 130 is arranged proximal the housing inlet 113 and configured to output a first signal corresponding to a first temperature of the portion of the exhaust gas stream entering the first housing via the housing inlet. The system 100 also includes a second temperature sensor 130 arranged proximal the housing outlet 112 and configured to output a second signal corresponding to a second temperature of the portion of the exhaust gas stream (e.g., processed gas) exiting the housing via the housing outlet 112.

Once the system 100 is deployed proximal an exhaust stack 102 in and/or on the building, the controller 150 can: sample these temperature sensors, such as at a rate of once per minute or once per hour; store these data in local memory; and/or stream these data to the remote computer system for further processing.

### 5. Controller and Communications

As described above, the controller 150 can: sample the foregoing sensors continuously or intermittently, such as once per minute; compress and store these raw data locally; and intermittently broadcast these raw data to the remote computer system, such as once per day.

Alternatively, the controller 150 can execute methods and techniques described below to locally process these raw data and then transmit derived data and insights to the remote computer system, such as once per day.

For example, the controller 150 can interpret a temperature difference between the portion of the exhaust gas stream entering the housing inlet 113 and exiting the housing outlet 112 based on signals from a set of temperature sensors. The controller 150 can then activate the heating element 116, activate the fan 115 to influence the portion of the exhaust gas stream moving through the housing at a second speed, and/or close the valve to prevent the exhaust gas stream from entering the housing inlet, in response to the temperature of constituent gas exiting the housing via the housing outlet 112 falling below the temperature of constituent gas entering the housing via the housing inlet 113 by more than a threshold temperature difference.

In another example, the controller 150 can selectively close the valve 140 to reduce the concentration of constituent gas from the exhaust gas stream moving through the emissions capture reaction vessel 110, in response to the first concentration of gas exceeding a threshold concentration of gas.

In yet another example, the controller 150 can selectively close the valve 140 to prevent the portion of the exhaust gas stream entering the housing 111 via the housing inlet 113, in response to the door 118 opening.

### 5.1 Remote Computer System

The remote computer system—such as a remote server—can receive raw data from the set of sensors (e.g., gas sensors, gas flow sensors, temperature sensors) installed in the building and can manipulate these raw data: to estimate a gas flow rate of constituent gas; to interpret a temperature difference of the exhaust gas stream entering and exiting the housing 111 throughout the processing cycle; and to estimate a gas absorption rate and total constituent gas absorbed by the reaction media during a period of time in order to achieve accurate and repeatable conveyance of gas through the emissions capture reaction vessel 110. The remote computer system can also selectively trigger actuators within the system 100 (e.g., a fan 115, a heating element 116, a valve 140); and to execute actions (e.g., generate prompts, generate notifications) prompting a user (e.g., manager, custodial staff, maintenance worker) affiliated with the building to service the emissions capture reaction vessel 110, as further described below.

### 6. Processing Cycle: Carbon Capture

Generally, the remote computer system can generate a processing cycle and transmit this processing cycle to the controller 150. The controller 150 can then execute the processing cycle, implemented by the system 100, to capture gas (e.g., carbon dioxide, greenhouse gases) from an exhaust stack 102 located within a building.

In one implementation, during a first segment of the processing cycle, the controller can trigger the fan 115 to extract a portion of an exhaust gas stream from a first access tap on the exhaust stack 102 into the housing inlet 113 of the emissions capture reaction vessel 110. Then, during a second segment of the processing cycle, the reaction media within the reaction media container 114 of the emissions capture reaction vessel 110 can: extract constituent gas (e.g., carbon dioxide) from the portion of the exhaust gas stream; and capture the constituent gas. The reaction media can later be removed and thereby sequestering the captured constituent gas for future periods of time (e.g., 10 years, 100 years, 1,000 years, 10,000 years). Lastly, during a third segment of the processing cycle, the system 100 can return the portion of the exhaust gas stream (e.g., processed gas) from the housing outlet 112 of the emissions capture reaction vessel 110 into a second access tap on the exhaust stack 102 located within the building. Upon termination of the processing cycle, the controller 150 can read raw data from the set of sensors 130 (e.g., gas sensors, gas flow sensors, temperature sensors) and manipulate these data to calculate an amount of constituent gas absorbed by the reaction media, a gas flow rate, a gas concentration difference, a temperature difference of gas between the exhaust gas stream entering the housing 111 via the housing inlet 113 and exiting the housing 111 via the housing outlet 112 of the emissions capture reaction vessel 110.

Alternatively, the controller 150 can transmit these raw data to the remote computer system and the remote computer system can manipulate these data to calculate an amount of constituent gas absorbed by the reaction media, a gas flow rate, a gas concentration difference, a temperature difference of gas between the exhaust gas stream entering the housing 111 via the housing inlet 113 and exiting the housing 111 via the housing outlet 112 of the emissions capture reaction vessel 110.

### 7. Metrics: Gas Flow Rate+Temperature Difference+Gas Mass Flux

Furthermore, the remote computer system can maintain a temperature difference between the housing inlet 113 and the housing outlet 112 of the emissions capture reaction vessel 110 and gas flow and mass flux of gas moving through the emissions capture reaction vessel 110.

In one implementation, the controller 150 can read raw data from the set of sensors 130 (e.g., gas sensors, gas flow sensors, temperature sensors) and manipulate these raw data to track a temperature difference of the exhaust gas stream between the housing inlet 113 and the housing outlet 112 of the emissions capture reaction vessel 110 and the gas flow in the emissions capture reaction vessel 110.

Alternatively, the controller 150 can transmit these raw data to the remote computer system throughout the processing cycle in (near) real time and then the remote computer system can manipulate these raw data to track a temperature difference of the exhaust gas stream between the housing inlet 113 and the housing outlet 112 of the emissions capture reaction vessel 110 and the gas flow in the emissions capture reaction vessel 110.

### 7.1 Threshold Temperature Difference

In one variation, during the processing cycle, the controller 150 and/or the remote computer system can access a first temperature of gas from a first temperature sensor 130 arranged proximal the housing inlet 113 and configured to detect a temperature of the exhaust gas stream entering the housing inlet 113 of the emissions capture reaction vessel 110 from the first access tap on the exhaust stack 102. The controller 150 and/or the remote computer system can then access a second temperature of gas from a second temperature sensor 130 arranged proximal the housing outlet 112 and configured to detect a temperature of the exhaust gas stream exiting the housing outlet 112 of the emissions capture reaction vessel 110. Accordingly, the controller 150 and/or remote computer system can interpret a temperature difference between the exhaust gas stream entering the housing inlet 113 and exiting the housing outlet 112 of the emissions capture reaction vessel 110 based on the first temperature and the second temperature. In response to the second temperature falling below the first temperature by more than a threshold temperature difference, the controller 150 and/or remote computer system can selectively close the valve 140 to prevent the exhaust gas stream from entering the housing inlet 113.

In another variation, the controller 150 and/or the remote computer system can implement methods and techniques described above to interpret a temperature difference between the portion of the exhaust gas stream entering the housing inlet 113 and the portion of the exhaust gas stream exiting the housing outlet 112 based on the first temperature of gas and the second temperature of gas. Then, in response to the second temperature falling below the first temperature by more than a threshold temperature difference, the controller 150 and/or the remote computer system can activate the heating element 116—arranged proximal the housing outlet 112 of the emissions capture reaction vessel 110—to increase the temperature of gas flowing through the emissions capture reaction vessel 110.

In yet another variation, the controller 150 and/or remote computer system can implement methods and techniques described above to interpret a temperature difference between the exhaust gas stream entering the housing inlet 113 and exiting the housing outlet 112 of the emissions capture reaction vessel 110 based on the first temperature and the second temperature. In response to the second temperature falling below the first temperature by more than a threshold temperature difference (e.g., between 210 degrees Fahrenheit to 250 degrees Fahrenheit), the controller 150 and/or remote computer system can selectively activate the fan 115 to influence the portion of the exhaust gas stream moving through the housing at a second speed greater than the first speed.

Therefore, the controller 150 and/or the remote computer system can manipulate a temperature difference of the exhaust gas stream to within a minimum threshold temperature difference in order to achieve minimal to no generation of constituent gases (e.g., carbon monoxide) within the building or combustion of gas during a processing cycle.

### 7.2 Gas Concentration

In one variation, during the processing cycle, the controller and/or remote computer system can access a first concentration of constituent gas from a first gas sensor 130 arranged proximal the housing inlet 113 and configured to detect gas entering the housing via the housing inlet 113 from the first access tap on the exhaust stack 102. The controller 150 and/or remote computer system can then access a second concentration of constituent gas from a second gas sensor 130 arranged proximal the housing outlet 112 and configured to detect gas exiting the housing 111 via the housing outlet 112. Then, in response to the first concentration of constituent gas falling below a threshold concentration of constituent gas (e.g., 10 parts-per-million, 50 parts-per-million), the controller 150 and/or remote computer system can trigger the valve 140 to a closed position to prevent the exhaust gas stream from flowing through the emissions capture reaction vessel 110 from the first access tap on the exhaust stack 102.

Therefore, the controller 150 and/or remote computer system can monitor gas flow of the exhaust gas stream entering into the housing 111 via the housing inlet 113 from the first access tap on the exhaust stack 102 and can trigger the valve 140 to prevent the exhaust gas stream from entering the housing 111 and thereby enabling a user to open the door 118 and service the emissions capture reaction vessel 110.

### 7.3 Reaction Media Capacity

In one implementation, the controller 150 and/or remote computer system can manipulate data from the set of sensors to track the portion of constituent gas (e.g., carbon dioxide) that is absorbed by the reaction media within the reaction media container 114 of the emissions capture reaction vessel 110. More specifically, during a particular time period, the controller 150 and/or remote computer system can leverage data from the set of sensors to calculate the constituent gas absorbed by the reaction media within the reaction media container 114 of the emissions capture reaction vessel 110 for each processing cycle.

For example, at an initial time prior to the processing cycle, the remote computer system can access a maximum constituent gas capacity. Then, during the processing cycle, the controller 150 can trigger the fan 115 within the housing of the emissions capture reaction vessel 110 to extract a portion of exhaust gas stream from the first access tap on the exhaust stack 102 via the housing inlet 113 and the reaction media within the reaction media container 114 of the emissions capture reaction vessel 110 can extract a constituent gas (e.g., carbon dioxide) from the portion of the exhaust gas stream and capture the constituent gas. The captured constituent gas can be stored within a container (e.g., tube, bucket, bottle) coupled to the reaction media container 114 as described above.

The controller 150 can then trigger the fan 115 to return the portion of exhaust gas stream (e.g., processed gas) from the housing outlet 112 back to the second access port on the exhaust stack 102 located within the building. During the processing cycle, the controller 150 can access raw data from the set of sensors and transmit these data to the remote computer system to calculate constituent gas absorbed by the reaction media during the processing cycle that is stored in the container (e.g., tube, bucket, bottle). Then, in response to the constituent gas absorbed by the reaction media falling below the maximum constituent gas capacity, the controller 150 can execute a second processing cycle.

During the second processing cycle, the controller 150 can trigger the fan 115 within the housing of the emissions capture reaction vessel 110 to extract a next portion of the exhaust gas stream from the first access port on the exhaust stack 102 via the housing inlet 113 and the reaction media within the reaction media container 114 can extract a constituent gas (e.g., carbon dioxide) from this portion of the exhaust gas stream and capture the constituent gas. The constituent gas can be stored within the container (e.g., tube, bucket, bottle) coupled to the reaction media container 114. The controller 150 can then trigger the fan 115 to return this portion of exhaust gas stream (e.g., processed gas) from the housing outlet 112 back to the second access port on the exhaust stack 102 located within the building.

Accordingly, the controller 150 and/or remote computer system can calculate constituent gas absorbed by the reaction media during the second processing cycle that is stored in the container (e.g., tube, bucket, bottle) and calculate a total constituent gas absorbed by the reaction media during the first processing cycle and the second processing cycle. Then, in response to the total constituent gas absorbed by the reaction media approaching the maximum constituent gas capacity of the reaction media, the controller 150 and/or remote computer system can generate a notification indicating removal and replacement of the container and the volume of reaction media within the reaction media container 114 of the emissions capture reaction vessel 110; and serve the notification to a user (e.g., manager, administrator, custodial staff, technician) affiliated with the building.

### 7.3.1 Reaction Media Removal and Reloading

Once the total constituent gas absorbed by the reaction media approaches the maximum gas capacity of the reaction media, a user (e.g., custodial staff, technician) affiliated with the building can open the door 118 of the emissions capture reaction vessel 110 and remove the reaction media container 114 and/or the container with the volume of reaction media and thus the total captured constituent gas, from the emissions capture reaction vessel 110. The user can then reload the reaction media container 114 with a new container with the volume of reaction media into the housing of the emissions capture reaction vessel 110.

In one variation, the user can receive the notification prompting the user to remove the container with the volume of reaction media and reload new reaction media within the emissions capture reaction vessel 110 via a user portal. The user can then remove the container with the reaction media housed within the reaction media container 114 and thus the total captured constituent gas and the container can be transported to a facility for sequestering. The user can then replace the container with a new container configured to house a volume of new reaction media.

For example, a computing device-accessible by custodial staff affiliated with the building—can receive the notification prompting custodial staff to replace the container with reaction media via the user portal. The custodial staff can then: turn the valve 140 to a closed position; open the housing 111 of the emissions capture reaction vessel 110; and remove the volume of reaction media and thus the total captured constituent gas in the container from the reaction media container 114 within the housing 111 into a bin that can be transported to a warehouse for sequestering. The user can then: replace the container with a new container with new reaction media; close the housing 111 of the emissions capture reaction vessel 110; and turn the valve 140 to an open position to enable gas to move from the access tap on the exhaust stack 102 into the housing inlet 113 of the emissions capture reaction vessel 110. The controller 150 can then execute a next processing cycle with the new reaction media and repeat these methods and techniques for each other processing cycle and for each other new reaction media.

Additionally or alternatively, the user can implement the methods and techniques described above to remove and replace the container with a new container with new reaction media into the reaction media container 114 arranged within the housing of the emissions capture reaction vessel 110 during a maintenance (e.g., cleaning, servicing) time period predefined by the user (e.g., manager, administrator, technician, custodial staff) affiliated with the building.

### 7. Variations: Set of Emissions Capture Reaction Vessels

The system 100 can be configured to include a set of emissions capture reaction vessels 110 (e.g., 3 emissions capture reaction vessels, 10 emissions capture reaction vessels, 20 emissions capture reaction vessels) to capture carbon corresponding to the carbon greenhouse gases (e.g., 2,000 parts-per-million of carbon dioxide, 10,000 parts-per-million of carbon dioxide, 80,000 parts-per-million of carbon dioxide) from an exhaust stack 102 coupled to a utility system-such as a boiler, a furnace, a water heater, a space heater, a drying machine, a fireplace, and/or a generator etc.—located within and/or on a building.

As shown in FIG. 3, in one implementation, the system 100 can be configured to include a set of emissions capture reaction vessels 110 connected in series for a low emitting exhaust stack 102 (e.g., a furnace emitting 10,000 parts-per-million of carbon dioxide) such that the container with reaction media within the reaction media container 114 of each emissions capture reaction vessel 110 can be replaced in sequential order according to a schedule.

As shown in FIG. 4, in another implementation, the system 100 can be configured to include a set of emissions capture reaction vessels 110 connected in parallel for a high emitting exhaust stack 102 (e.g., a boiler emitting 80,000 parts-per-million of carbon dioxide) such that the container with reaction media within the reaction media container 114 of each emissions capture reaction vessel 110 can be replaced during a particular time period.

### 7.1 Variation: Emissions Capture Reaction Vessels Connected in Parallel

In one variation, the system 100 can be configured to include a set of (e.g., two, three) emissions capture reaction vessels 110 connected in parallel such that the system 100 can capture carbon, from an exhaust stack 102 emitting a low carbon dioxide concentration emitting exhaust stack (e.g., a furnace emitting 10,000 parts-per-million of carbon dioxide) within a small-scale building (e.g., educational building, office building), in the set of emissions capture reaction vessels 110.

In one implementation, the system 100 can include: two emissions capture reaction vessels 110; a housing inlet manifold 126; a housing outlet manifold 128; a set of sensors 130; and a primary controller 160. In this example, the housing inlet manifold 126 is fluidly coupled to a first access tap at a first height on an exhaust stack 102 coupled to a furnace within an educational building and the housing outlet manifold 128 is fluidly coupled to a second access tap at a second height, greater than the first height, on the exhaust stack 102 coupled to the furnace.

The first emissions capture reaction vessel 110, in the set of emissions capture reaction vessels 110, includes: a first housing 111; a first housing inlet 113 arranged on the first housing 111, coupled to the housing inlet manifold 126, and configured to receive a first portion of exhaust gas stream (e.g., high concentration carbon dioxide), exhausting through the exhaust stack 102 and inbound to the first emissions capture reaction vessel 110, via the first access tap on the exhaust stack 102; and a first housing outlet 112, arranged on the first housing 111, coupled to the housing outlet manifold 128, and configured to return the first portion of exhaust gas stream (e.g., low concentration carbon dioxide) to the second access tap on the exhaust stack 102. The second emissions capture reaction vessel 110 includes: a second housing 111; a second housing inlet 113 arranged on the second housing 111, coupled to the housing inlet manifold 126, and configured to receive a second portion of exhaust gas stream (e.g., high concentration carbon dioxide), exhausting through the exhaust stack 102 and inbound to the second emissions capture reaction vessel 110, via the first access tap on the exhaust stack 102; and a second housing outlet 112 arranged on the second housing 111, coupled to the housing outlet manifold 128, and configured to return the second portion of the exhaust gas stream (e.g., low concentration carbon dioxide) to the second access tap on the exhaust stack 102.

For example, during a first time period, the primary controller 160 can trigger a first fan 115 arranged within the first emissions capture reaction vessel 110 to extract a first portion of exhaust gas stream from the first access tap on the exhaust stack 102 into the first housing inlet 113 of the first emissions capture reaction vessel 110 via the housing inlet manifold 126. The first emissions capture reaction vessel 110 can absorb a constituent gas (e.g., high concentration carbon dioxide) from the first portion of exhaust gas stream and capture the constituent gas (e.g., high concentration carbon dioxide) via the reaction media housed within the first reaction media container 114 and return the portion of exhaust gas stream (e.g., low concentration carbon dioxide) from the first housing outlet 112 to the second access tap on the exhaust stack 102 via the housing outlet manifold 128.

During the first time period, the primary controller 160 can trigger a second fan 115 arranged within the second emissions capture reaction vessel 110 to extract a second portion of exhaust gas stream from the first access tap on the exhaust stack 102 into the first housing inlet 113 of the first emissions capture reaction vessel 110 via the housing inlet manifold 126. The second emissions capture reaction vessel 110 can similarly absorb the constituent gas (e.g., high concentration carbon dioxide) from the second portion of exhaust gas stream and capture the constituent gas (e.g., high concentration carbon dioxide) via the reaction media housed within the second reaction media container 114 and return the portion of exhaust gas stream (e.g., low concentration carbon dioxide) from the second housing outlet 112 to the second access tap on the exhaust stack 102 via the housing outlet manifold 128.

During a second time period succeeding the first time period, the primary controller 160 can: receive a first signal from a first gas flow sensor 130 corresponding to a first gas flow rate of constituent gas from the exhaust gas stream entering the first housing 111 via the first housing inlet 113; and receive a second signal from a second gas flow sensor 130 corresponding to a second gas flow rate of constituent gas from the exhaust gas stream exiting the second housing 111 via the second housing outlet 112. The primary controller 160 can then estimate a gas flow rate of constituent gas based on the first signal and the second signal, and, in response to the total constituent gas absorbed by the reaction media in each emissions capture reaction vessel 110 approaching a constituent gas capacity of the volume of reaction media, the primary controller 160 can generate a notification indicating removal and replacement of the reaction media within the reaction media container 114 of each emissions capture reaction vessel 110; and transmit the notification to a user (e.g., manager, administrator, custodial staff, technician) affiliated with the educational building via a user portal.

Therefore, the system 100 can be configured to include a set of emissions capture reaction vessels 110 to capture carbon from a low carbon dioxide concentration emitting exhaust stack 102 coupled to a furnace within and/or on an educational building and the reaction media within each emissions capture reaction vessel 110 can be replaced during a particular time period.

### 7.2 Variation: Emissions Capture Reaction Vessels Connected in Series

In one variation, the system 100 can be configured to include a set of emissions capture reaction vessels 110 connected in series such that the system 100 can capture carbon, from a high carbon dioxide concentration emitting exhaust stack 102 (e.g., a boiler emitting 80,000 parts-per-million of carbon dioxide) within a large-scale building (e.g., industrial building), in the set of emissions capture reaction vessels 110.

In one implementation, the system 100 can include: two emissions capture reaction vessels 110; a set of sensors 130; and a primary controller 160. The first emissions capture reaction vessel 110 includes: a first housing inlet 113 configured to receive a portion of exhaust gas stream (e.g., high concentration carbon dioxide) from the first access tap on the exhaust stack 102; and a first housing outlet 112 configured to feed processed gas (e.g., low concentration carbon dioxide) into a second housing inlet 113 of the second emissions capture reaction vessel 110. The second emissions capture reaction vessel 110 includes the second housing inlet 113 configured to receive the processed gas from the first housing outlet 112 of the first emissions capture reaction vessel 110 and a second housing outlet 112 configured to return the processed gas (e.g., low concentration carbon dioxide) to the second access tap on the exhaust stack 102.

For example, during a processing cycle, the primary controller 160 can trigger a first fan 115 to extract a first portion of exhaust gas stream from the exhaust stack 102 into the first housing inlet 113 of the first emissions capture reaction vessel 110. During a first time period, the first emissions capture reaction vessel 110 can then capture constituent gas from the portion of the exhaust gas stream via reaction media within the first reaction media container 114 and feed processed gas (e.g., low concentration carbon dioxide) from the first housing outlet 112 to the second housing inlet 113 of the second emissions capture reaction vessel 110. During a second time period succeeding the first time period, the second emissions capture reaction vessel 110 can capture constituent gas via reaction media within the second reaction media container 114 and return processed gas (e.g., low concentration carbon dioxide) from the second housing outlet 112 to the second access tap on the exhaust stack 102.

During a second time period succeeding the first time period, the primary controller 160 can: receive a first signal from a first gas flow sensor 130 corresponding to a first gas flow rate of constituent gas from the exhaust gas stream entering the first housing 111 via the first housing inlet 113; and receive a second signal from a second gas flow sensor 130 corresponding to a second gas flow rate of constituent gas from the exhaust gas stream exiting the second housing 111 via the second housing outlet 112. The primary controller 160 can then: estimate a gas flow rate of constituent gas based on the first signal and the second signal; and, in response to the total constituent gas absorbed by the reaction media in each emissions capture reaction vessel 110 approaching a constituent gas capacity of the volume of reaction media, generate a notification indicating removal and replacement of the reaction media within the reaction media container 114 of each emissions capture reaction vessel 110; and transmit the notification to a user (e.g., manager, administrator, custodial staff, technician) affiliated with the educational building via a user portal.

Therefore, the system 100 can be configured to include a set of emissions capture reaction vessels 110 to capture carbon from a high carbon dioxide concentration emitting exhaust stack 102 connected to a boiler within and/or on an industrial building and the first emissions capture reaction vessel 110 can be replaced during a first time period and the second emissions capture reaction vessel 110 can be replaced during a second time period succeeding the first time period.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

What is claimed is:

1. A system for processing an air supply comprising:
a housing;
a housing inlet arranged on the housing and configured to receive a portion of the air supply of an external area of the housing;
a filter arranged within the housing at the housing inlet and configured to remove particular matter or a particular gas from the portion of the air supply entering the housing inlet;
a reaction media arranged within the housing, the reaction media configured to receive the filtered portion of the air supply and capture a portion of a constituent gas from the filtered portion of the air supply;
a housing outlet arranged on the housing and configured to return the portion of the air supply exiting the reaction media back to the external area of the housing; and
a fan arranged within the housing and configured to influence the portion of the air supply from the housing inlet, through the reaction media, and through the housing outlet.

2. The system of claim 1, wherein the filter is arranged in series with the reaction media.

3. The system of claim 1, further comprising:
a set of sensors; and
a controller that receives outputs of the set of sensors and controls the system to process both combustion exhaust gas and non-combusted gas.

4. The system of claim 3, wherein the set of sensors include a gas sensor, a temperature sensor, and a gas flow sensor.

5. The system of claim 1, further comprising:
a first gas sensor arranged proximal the housing inlet to output a first signal corresponding to a first concentration of the constituent gas from the portion of the air supply entering the housing inlet; and
a second gas sensor arranged proximal the housing outlet to output a second signal corresponding to a second concentration of the constituent gas from the portion of the air supply exiting the reaction media.

6. The system of claim 5, further comprising:
a controller configured to estimate a constituent gas absorption rate by the reaction media based on a difference between the first concentration of the constituent gas and the second concentration of the constituent gas.

7. The system of claim 1, further comprising:
a gas sensor to output a signal corresponding to a concentration of the constituent gas from the portion of the air supply entering the housing inlet; and
a controller to receive the signal from the gas sensor, and based on the concentration of the constituent gas being above a threshold amount, to cause the fan to influence the portion of the air supply moving through the housing at an increased speed.

8. The system of claim 1:
wherein the housing inlet is configured to receive the portion of the air supply which is characterized by a first carbon dioxide concentration;
wherein the reaction media absorbs carbon dioxide from the filtered portion of the air supply to capture the portion of the constituent gas; and
wherein the housing outlet is configured to return the portion of the air supply back to the external area of the housing, the portion of the air supply returned characterized by a second carbon dioxide concentration less than the first carbon dioxide concentration.

9. The system of claim 1, further comprising:
a first access tap to couple the housing inlet to an exhaust stack to receive the portion of the air supply; and
a second access tap to couple the housing outlet to the exhaust stack to return the portion of the air supply exiting the reaction media.

10. The system of claim 1, wherein the housing inlet receives the portion of the air supply from a heating ventilation and air conditioning (HVAC) system.

11. The system of claim 1, wherein the housing inlet receives the portion of the air supply from ambient indoor air.

12. The system of claim 1, further comprising:
a reaction media container housing the reaction media.

13. The system of claim 1, further comprising:
a set of sensors; and
a controller configured to execute a processing cycle to filter the portion of the air supply and to capture the portion of the constituent gas from the filtered portion of the air supply;
wherein during a first segment of the processing cycle, the controller triggers the fan to draw the portion of the air supply into the housing inlet;
wherein during a second segment of the processing cycle, the reaction media captures the portion of the constituent gas from the filtered portion of the air supply;
wherein during a third segment of the processing cycle, the portion of the air supply exiting the reaction media is returned back to the external area of the housing; and
upon termination of the processing cycle, the controller receives outputs from the set of sensors to calculate one or more of an amount of the constituent gas captured by the reaction media, a gas flow rate, and a gas concentration difference.

14. The system of claim 13, further comprising:
during the second processing cycle, the controller triggers the fan to draw a next portion of the air supply into the housing inlet.

15. A method for processing an air supply comprising:
receiving, at a housing inlet arranged on a housing, a portion of the air supply of an external area of the housing;
filtering particular matter or a particular gas from the portion of the air supply entering the housing inlet by a filter arranged within the housing at the housing inlet;
capturing a portion of a constituent gas from the filtered portion of the air supply by a reaction media arranged within the housing; and
returning the portion of the air supply exiting the reaction media back to the external area of the housing via a housing outlet arranged on the housing.

16. The method of claim 15, further comprising:
influencing the portion of the air supply from the housing inlet, through the reaction media, and through the housing outlet by a fan arranged within the housing.

17. The method of claim 15, further comprising arranging the filter in series with the reaction media.

18. The method of claim 15, further comprising:
determining a first concentration of the constituent gas from the portion of the air supply entering the housing inlet; and
determining a second concentration of the constituent gas from the portion of the air supply exiting the reaction media.

19. The method of claim 18, further comprising:
estimating a constituent gas absorption rate by the reaction media based on a difference between the first concentration of the constituent gas and the second concentration of the constituent gas.

20. The method of claim 15, further comprising:
determining a concentration of the constituent gas from the portion of the air supply entering the housing inlet; and
based on the concentration of the constituent gas being above a threshold amount, causing a fan to influence the portion of the air supply moving through the housing at an increased speed.
